(19) United States
(12) Patent Application Publication
(10) Pub. No.: US 2022/0115148 A1
(43) Pub. Date: Apr. 14, 2022

(54) SELF-ASSESSMENT OF MACHINE LEARNING

(71) Applicant: Arm Cloud Technology, Inc., San Jose, CA (US)

(72) Inventors: Saina LAJEVARDI, San Jose, CA (US); Bernard BURG, Menlo Park, CA (US); Michael LUBINSKY, San Jose, CA (US)

(21) Appl. No.: 17/067,314

(22) Filed: Oct. 9, 2020

(51) Int. Cl. G16Y 40/40; G16Y 40/20; G16Y 20/20; G06K 9/62; G06N 20/00

(52) U.S. Cl. CPC G16Y 40/40; G16Y 40/20; G06N 20/00; G06K 9/627; G06K 9/6264; G16Y 20/20

(57) ABSTRACT

A system includes a device management infrastructure arranged to process a set of training data using a data transformation model to generate first characteristic data indicative of values of one or more characteristics for the training data, and an electronic device communicatively coupled to the device management infrastructure. The device includes memory circuitry arranged to store a machine learning model trained using the set of training data, and a copy of the data transformation model. The device is arranged to process a set of input data using the data transformation model to generate second characteristic data indicative of values of said set of data characteristics for the input data. The device and/or the device management infrastructure is arranged to determine whether the first characteristic data and the second characteristic data satisfy one or more consistency criteria indicative of consistency between the training data and the input data.

### BACKGROUND OF THE INVENTION

### Field of the Invention

The present disclosure relates to self-assessment of a machine learning model running on a device. The disclosure has particular, but not exclusive, relevance to self-assessment of a machine learning model running on an Internet of Things (IoT) device.

### Description of the Related Technology

The Internet of things (IoT) describes a system of interconnected electronic devices, each of which has a unique identifier and a capability to transfer data over the Internet without requiring human intervention. Examples of IoT devices range from household appliances such as lighting fixtures, doorbells, audio speakers, televisions, washing machines and refrigerators, to energy or water meters, sensing devices and vehicles. Providing such devices with network connectivity allows for a wide range of functionalities to be implemented, for example performance monitoring, data gathering, real-time analytics and/or remote control of devices. In many cases, IoT devices make use of machine learning models to implement such functionalities.

In some cases, a single enterprise or owner may be responsible for a large number of IoT devices, for example hundreds, thousands, or tens of thousands of devices. Management of a large number of devices, including for example managing firmware versions running on the devices, managing device security, and training machine learning models running on the devices, requires significant resources and infrastructure. Cloud-based device management platforms, such as the Arm® Pelion® IoT platform, have been developed to reduce the burden of managing IoT devices, whilst providing the device owner/operator with a customizable level of control over the devices.

During the period in which an IoT device is deployed, properties of input data processed by the device may change. This may occur, for example, due to sensor degradation, human error during deployment or maintenance, or physical changes to the device and/or the environment in which device is deployed. If the device is arranged to process input data using a machine learning model, and the input data no longer sufficiently resembles the training data upon which the machine learning model was trained, the machine learning model may not be competent for use with the new input data. This may result in erroneous outputs from the machine learning model, which may in turn result in suboptimal performance or malfunctioning of the device. The suboptimal performance or malfunctioning may go undetected for a significant period of time, potentially having costly or dangerous consequences.

### SUMMARY

According to a first aspect, there is provided a system including a device management infrastructure arranged to process a set of training data using a data transformation model to generate first characteristic data indicative of values of one or more characteristics for the set of training data, and an electronic device communicatively coupled to the device management infrastructure. The device includes memory circuitry arranged to store a machine learning model trained using the set of training data, and a copy of the data transformation model. The device is arranged to process a set of input data using the copy of the data transformation model to generate second characteristic data indicative of values of said set of data characteristics for the set of input data. The device and/or the device management infrastructure is arranged to determine whether the first characteristic data and the second characteristic data satisfy one or more consistency criteria indicative of consistency between the set of training data and the set of input data.

According to second aspect, there is provided device management system. The device management system is arranged to process a set of training data for a machine learning model using a data transformation model to generate first characteristic data indicative of values of one or more characteristics for the set of training data, receive second characteristic data from an electronic device indicative of values of said one or more characteristics for a set of input data generated by the electronic device, and determine whether the first characteristic data and the second characteristic data satisfy one or more consistency criteria indicative of consistency between the set of training data and the set of input data.

According to a third aspect, there is provided a device including memory circuitry and one or more sensors. The memory circuitry is arranged to store a machine learning model; and a data transformation model. The device is arranged to receive first characteristic data from a device management system indicative of one or more characteristics for a set of training data used to train the machine learning model, generate a set of input data using the one or more sensors, process the generated set of input data using the data transformation model to determine second characteristic data indicative of values of a set of data characteristics for the set of input data, and determine whether the first characteristic data and the second characteristic data satisfy one or more consistency criteria indicative of consistency between the set of training data and the set of input data.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic block diagram representing a system for managing IoT devices in accordance with examples;

FIG. 2 is a schematic block diagram representing the device management system shown in FIG. 1;

FIG. 3 is a schematic block diagram representing one of the IoT devices shown in FIG. 1;

FIG. 4 is a flow diagram representing a first example of a method of assessing competence of a machine learning model;

FIGS. 5A and 5B schematically represent a comparison between two data sets in accordance with examples.

FIG. 6 is a flow diagram representing a second example of a method of assessing competence of a machine learning model; and

### DETAILED DESCRIPTION OF CERTAIN INVENTIVE EMBODIMENTS

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

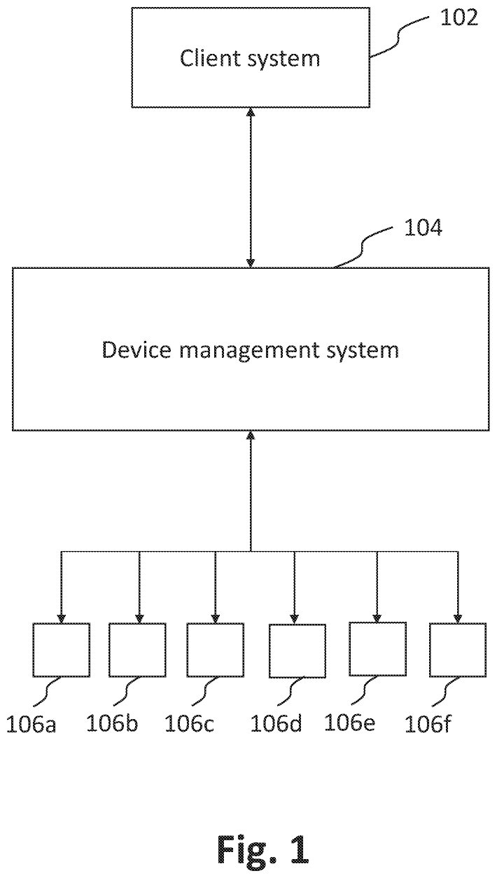

FIG. 1 shows a client system 102, a device management system 104, and multiple network-enabled IoT devices, referred to collectively or individually as devices 106 (of which six devices 106a-f are shown). The device management system 104 in this example is distributed over multiple networked servers, providing cloud-based computing services to users such as the operator of the client system 102. The devices 106 in this example are wireless devices and are able to communicate with the device management system 104 via a core network and a radio access network. In this example, the devices 106 communicate using wireless signals in accordance with the narrowband IoT (NB-IoT) standard, which has been developed from the Long Term Evolution (LTE) and Long Term Evolution-Advanced (LTE-A) standards to address specific requirements associated with IoT devices, including potentially large numbers of devices within a given area, low data rates, low power consumption, and low signal-to-noise ratio (for example where a device is deployed in a remote or enclosed area).

An IoT device as described above typically include one or more firmware applications for implementing the functionality of the device. The firmware application is part of a firmware image written to a read-only memory (ROM) of a device, comprising low-level machine-readable instructions for implementing various functionalities of the device (for example, controlling hardware or performing real-time analytics). Firmware is typically installed at the time of manufacturing of a device, but may be updated during the life-cycle of the device, for example to add security patches or to improve or modify the functionality of the device. In cases where an IoT device implements a machine learning model, the machine learning model may be included as part of the firmware image, and updating the firmware image may include updating the machine learning model, for example after the machine learning model has undergone training.

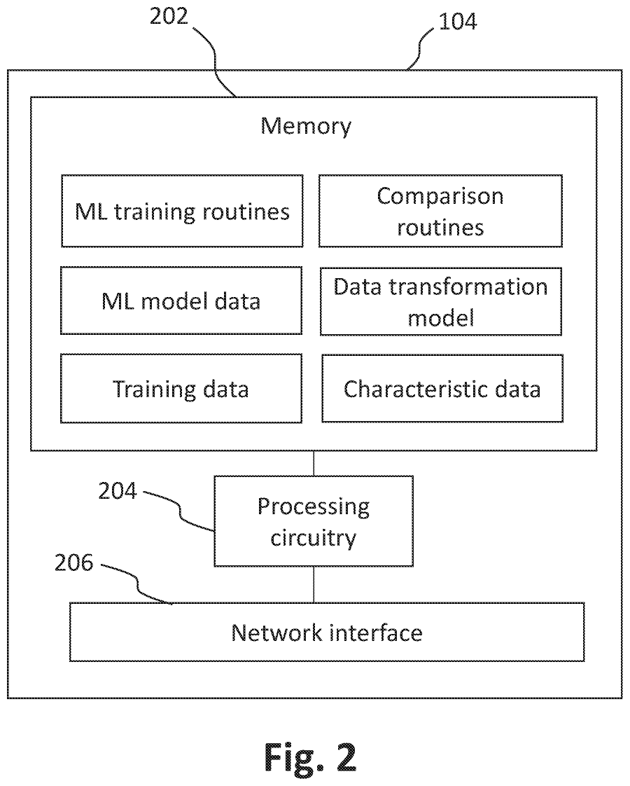

As shown in FIG. 2, the device management system 104 includes memory 202, processing circuitry 204, and a network interface 206 for communicating with the devices 106 and the client system 102. The device management system 104 is responsible for a range of functions with respect to the devices 106, including managing firmware versions running on the devices 106, managing device security for the devices 106, and training machine learning models running on the devices 106. The memory 202 stores various routines and data for implementing these functionalities. In particular, the memory 202 stores machine learning model data, which may include for example network architectures, hyperparameters and trainable parameters of one or more machine learning models. The memory 202 further stores training data and one or more training routines for training the one or more machine learning models. In accordance with the present disclosure, the memory 202 further stores a data transformation model, which is arranged to process a set of input data to generate characteristic data indicative of values of one or more characteristics of the set of input data. The memory 202 further stores characteristic data generated by applying the data transformation model to various sets of input data, and one or more comparison routines for comparing characteristic data corresponding to different sets of input data.

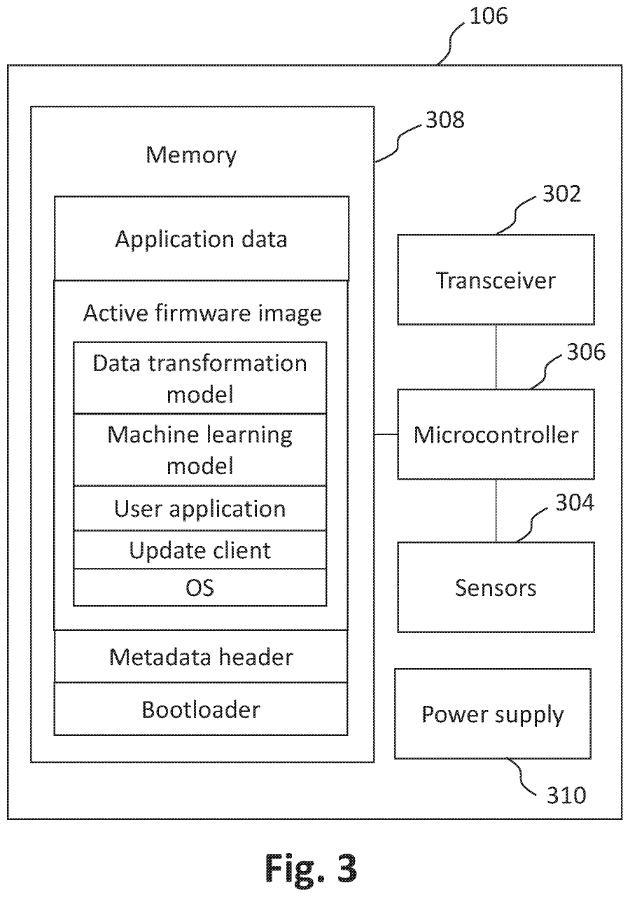

As shown in FIG. 3, each of the devices in this example 106a-f includes a radio transceiver 302, one or more sensors 304, processing circuitry in the form of a microcontroller 306, non-volatile flash memory 308 and a power supply 310. The memory 308 holds code including a bootloader, a metadata header and an active firmware image. The active firmware image is stored in an active image slot in the memory 308, and includes an operating system (OS), an update client, and a user application. In the present example, the devices 106 use the Mbed® OS by Arm®, though other choices of OS may be used, for example a Linux-based OS such as the Raspberry Pi® OS or a real-time operating systems (RTOS) such as RTX by Arm® or FreeRTOS. The active firmware image further includes a machine learning model and a copy of the data transformation model stored in the memory 202 of the device management system 104. The user application is arranged to call the machine learning model and the data transformation model as necessary, as will be explained in further detail hereinafter. The memory 308 also includes space for temporary storage of application data, which includes input data generated using the sensors 304 and characteristic data indicating values of one or more characteristics for the input data, as determined using the copy of the data transformation model.

In the example of FIG. 3, memory addresses of the memory 308 run from bottom to top as depicted, such that the bootloader is placed at an allocated start address (for example, address 0x0). The bootloader is therefore executed by the microcontroller 306 each time the device 106 boots. The metadata header contains information pertaining to the active firmware image, including a hash of the active firmware image, and is used by the bootloader for validating the active firmware image before loading. A new metadata header is provided each time the active firmware image is updated on the device 106. The update client is responsible for communicating with the device management system 104 to handle firmware updates on the device 106. A firmware update may be provided as an entirely new firmware image or as a differential update, also referred to as a delta update or a delta image. A differential update includes only a modified portion or portions of the firmware image, along with information indicating which part the active firmware image needs to be replaced. This saves network resources and energy consumed by the device 106, for example when a firmware update only includes small code changes. In the present example, the device management system 104 is arranged to update the machine learning model running on the device 106 when certain criteria are satisfied, as will be explained in more detail hereafter.

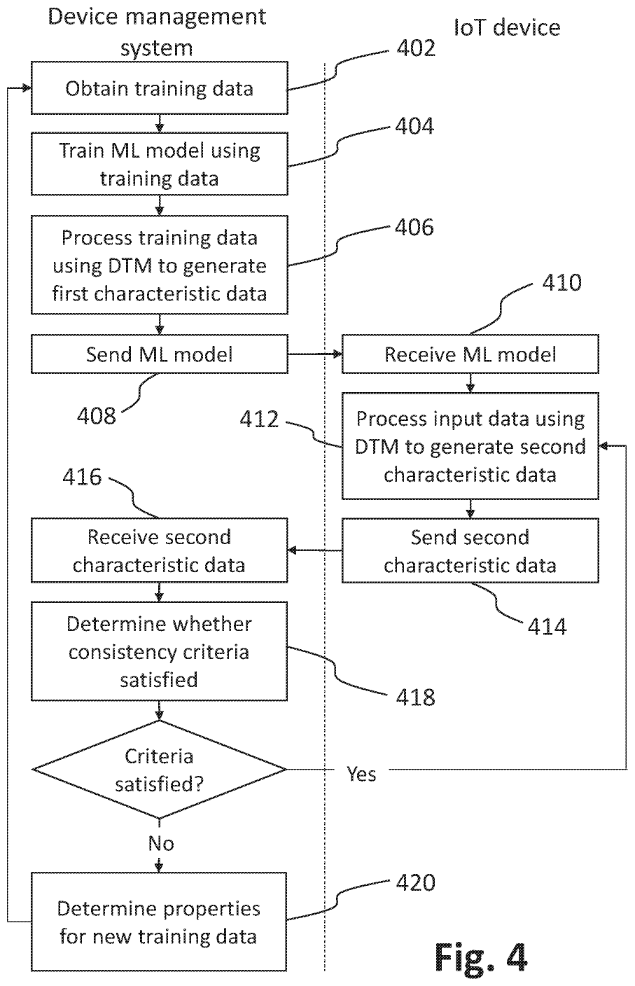

FIG. 4 shows an example of a method performed by the device management system 104 and one of the devices 106 to automatically assess the competence of a machine learning model running on the device 106. The machine learning model may be a supervised machine learning model such as a classification or regression model, an unsupervised machine learning model, a decision-making agent trained using reinforcement learning, or any other type of model that is trained automatically without explicit human input.

The device management system 104 obtains, at 402, a set of training data for training the machine learning model. The set of training data includes individual data points, each of which has one or more numerical components. Depending on the specific application, the set of training data may for example be collected from devices 106 which have already been deployed, retrieved from a database of historic data, collected automatically or manually from a laboratory or other test facility, or generated artificially from simulations. The training data may be labeled training data for use in training a supervised machine learning model or may be unlabeled training data for use in training an unsupervised machine learning model. The training data may alternatively be indicative of observed states of an environment, actions performed by a decision-making agent in said states of the environment, and rewards associated with the performance of those actions, for training the decision-making agent using reinforcement learning.

The device management system 104 trains, at 404, the machine learning model using the set of training data obtained at 402. Any suitable training method may be used, where the suitability of different methods will depend on the nature of the machine learning model. After the machine learning model has been trained (for example when the machine learning model satisfies predetermined performance criteria or convergence criteria, or when the entire set of training data has been used for training), the machine learning model is ready for deployment on the device 106. When deployed, the machine learning model will process input data to perform the task for which the machine learning model is trained. The machine learning model is expected to be competent to perform its intended function when processing input data that closely resembles the set of training data. Depending on the properties of the machine learning model, the machine learning model may also be able to generalize to input data which differs slightly from the training data. However, it is not expected that the machine learning model will perform adequately with input data having significantly different properties to those of the set of training data.

The device management system 104 processes, at 406, the set of training data using the data transformation model, to generate first characteristics data indicative of values of one or more characteristics for the set of training data. The characteristics may include, for example, mathematical moments such as mean, variance, skewness, kurtosis, and higher moments for data points in the set of training data, and/or other parameters of a distribution from which the data points are assumed to be sampled, estimated for example using the generalized method of moments (GMM). The characteristics may additionally, or alternatively, include maximum or minimum values for one or more components of the data points, and/or confidence intervals for one or more components of the data points. The characteristics are chosen to provide salient information about the underlying distribution from which it is assumed that the training data points are sampled.

The device management system 104 sends, at 408, the trained machine learning model to the device 106. Sending the trained machine learning model may involve sending an entire replacement machine learning model, or may instead involve sending updated parameter values for the machine learning model (for example, weights and biases where the model is based on a neural network architecture). The trained machine learning model may be transmitted to the device 106 as a differential update as described above, or may be transmitted as part of an entirely new firmware image. The device 106 receives the trained machine learning model at 410, and performs a firmware update such that the updated active firmware image on the device 106 incorporates the trained machine learning model. The device 106 reboots, and upon successful authentication of the firmware update by the bootloader on the device 106, begins to process input data generated by the sensors 304 using the trained machine learning model.

The device 106 processes, at 412, the input data generated by the sensors 304 using the copy of the data transformation model stored in the memory 308, to generate second characteristic data indicative of values of the one or more characteristics for the set of input data. The device 106 may apply the data transformation model in an iterative/streaming fashion, resulting in substantially continuous monitoring of the input data as the input data is generated, or the device 106 may apply the data transformation model in a batch fashion, for example by buffering input data generated by the sensors 304 in the memory 308, and processing the buffered input data intermittently using the data transformation model. The data transformation model may be applied periodically, for example every hour, every day, or at any other suitable frequency depending on the application. The data transformation model may alternatively be applied when a predetermined volume of input data has been generated, for example when a predetermined number of input data points have been generated, which may be appropriate when input data is not generated at a constant frequency. In another example, the device 106 may only be operational during certain times, for example only during daytime hours or only during the nighttime hours. In such cases, the device 106 may buffer input data during the time that the device 106 is operational, and then apply the data transformation model when the device 106 is not required to perform its usual functions. The microprocessor 306 of a given device 106 may be a relatively basic processor with limited processing resources, and accordingly may not be suitable for performing multiple tasks simultaneously. It therefore may be particularly advantageous to apply the data transformation model at a time when the microprocessor 306 is otherwise relatively inactive.

The device 106 sends, at 414, the second characteristic data to the device management system 104 and the device management system 104 receives the second characteristic data at 416. In cases where the data transformation model is applied in a batch fashion, the device 106 may send second characteristic data each time the data transformation model is applied. In cases where the data transformation model is applied in a streaming fashion, the device 106 may send second characteristic data periodically or when a certain amount of input data has been processed. By applying the data transformation model and/or sending the second characteristic data at a relatively low frequency compared with the frequency at which the input data is generated, the device 106 can save power and bandwidth use, both of which are important consideration for IoT devices. In any case, the data transformation model should be applied frequently enough to substantially mitigate costs or dangers associated with the device 106 operating with input data that is out of the range of competence of the on-board machine learning model.

The device management system 104 determines, at 418, whether the first characteristic data and the second characteristic data satisfy one or more consistency criteria. The consistency criteria are designed to measure whether the training data and the input data are sufficiently similar that the trained model is deemed competent for use with the input data. The consistency criteria may include, for example, a difference between a value of a characteristic for the training data and a value of the same characteristic for the input data being less than a specified threshold value. In this way, the consistency criteria can measure whether the set of input data sufficiently resembles the set of training data. The consistency criteria may include a predetermined distance between values of one or more characteristics for the two data sets being less than a specified value, or any other suitable metric for measuring a distance between distributions, such as a Kullback-Leibler divergence or other measure of divergence. Additionally, or alternatively, the consistency criteria may include values of one or more characteristics for the set of input data, for example a range or confidence interval, falling within limits depending on corresponding values for the set of training data. In this way, the consistency criteria can determine whether values for the set of input extend beyond a region for which the set of training data is deemed competent.

If the device management system 104 determines at 418 that the first characteristic data and the second characteristic data satisfy the one or more consistency criteria, the device 106 continues operating using the trained machine learning model, and routine returns to 412 to process the next set of input data at the next designated time.

If the device management system 104 determines at 418 that the first characteristic data and the second characteristic data do not satisfy the one or more consistency criteria, the device management system 104 determines, at 420, properties for a new set of training data for retraining the machine learning model running on the device 106. The device management system 104 determines the properties for the new set of training data in dependence on the second characteristic data and, optionally, the first characteristic data. In a first example, the device management system 104 may determine that the machine learning model should be retained, either from scratch or in a continued manner, using a new set of training data with properties consistent with those of the set of input data. This may be suitable if, for example, the device 106 is deployed in a new environment, and the properties of the input data generated by the sensors 304 in the new environment are not consistent with those of the training data (which may correspond to a different environment). The device management system 104 may, for example, send a request to the device 106 to send input data generated at the device 106 to the device management system 104, for use as new training data for the machine learning model. Alternatively, the device management system 104 may generate simulated training data with properties corresponding to those of the input data, or may output a request to a human user or automated system to collect new training data based on the determined properties.

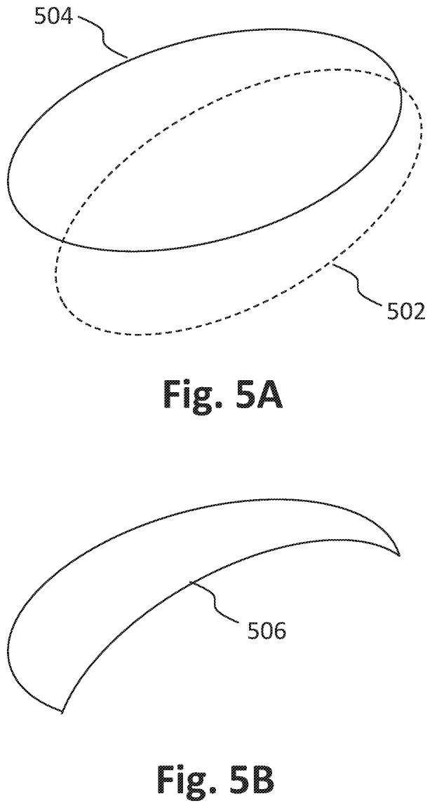

In the example described above, the device management system 104 determines properties for the new set of training data such that the new set of training data resembles the input data generated by the sensors 304 at the device 106. However, in some cases at least a portion of the set of input data will resemble the original set of training data. In other words, the distribution of the set of input data may overlap or intersect with the distribution of the set of training data. In this case, it may not be efficient to use a new set of training data that resembles the entire set of input data, because the machine learning model is already competent for use with input data in the overlapping region of the distributions. In FIG. 5A, the dashed oval 502 schematically represents a two-dimensional set of training data used to train a machine learning model. The shape of the dashed oval 502 is derived from the first characteristic data such that most if not all of the set of training data falls within the dashed oval 502 (the set of training data may include outliers which fall outside the indicated region). An arbitrarily complex model of a distribution of data points can be generated using mathematical moments determined from samples drawn from the distribution, and therefore in an example where the first characteristic data includes mathematical moments, the first characteristic data can be used to determine a model of the underlying distribution from which the set of training data is assumed to be sampled. The solid oval 504 schematically represents a set of input data generated by the device 106. It is observed that the ovals 502, 504 overlap, and therefore the machine learning model is deemed competent for use with input data lying within the overlap region. However, the machine learning model may not be competent for use with input data not lying within the overlap region, i.e. input data lying within the region 506 shown in FIG. 5B. In order for the machine learning model to be competent for use with the entire set of input data, the machine learning model may be retrained using a new set of training data such that the properties of the new set of training data are consistent with the non-overlapping region 506.

The device management system 104 may determine properties for the new set of training data corresponding only to a portion of the input data, for example the non-overlapping region 506 shown in FIG. 5B. In an example in which the first and second characteristic data indicate values of one or more mathematical moments, values of those moments for the non-overlap region 506 may be calculated from values of the moments for the set of training data and values of the moments for the set of input data, using appropriate transformation rules (including, for example, analogues of the Huygens-Steiner theorem and the method of composite parts for combining moments of inertia). In other examples, the device management system 104 may use other methods to determine properties for the new set of training data. For example, the device management system 104 may use the original set of training data to train a machine learning classifier, which can then be used to label candidate training data points as being consistent with the original set of training data or inconsistent with the original set of training data. Candidate training data points which are consistent with the original set of training data may be omitted from the retraining of the machine learning model. Any suitable machine learning classifier may be used, for example based on a linear classification model or a neural network model.

The method described above with reference to FIG. 4 provides a means of monitoring input data processed by a machine learning model running on a device 106. The second characteristic data generated by the device 106 occupies significantly less data volume than the set of input data that the second characteristic data represents. Therefore, sending the second characteristic data to the device management system 104 is possible using relatively few network resources and relatively little power at the device 106.

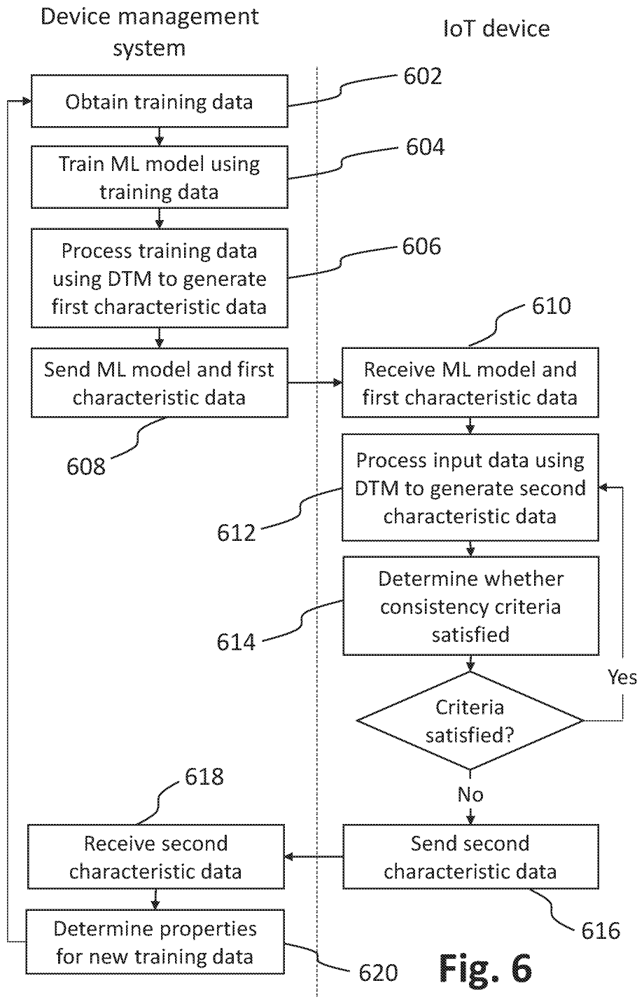

FIG. 6 shows a second example of a method performed by the device management system 104 and one of the devices 106. In this example, the memory 202 of the device 106 stores, in addition to the machine learning model and the copy of the data transformation model, a comparison routine for determining whether two sets of characteristic data are consistent. Items 602-612 of the method are identical to items 402-412 of FIG. 4, except that at 608, the device management system 104 sends the first characteristic data to the device 106 along with the trained machine learning model. The device 106 receives the first characteristic data and the trained machine learning model at 610.

The device 106 determines, at 614, whether the first characteristic data and the second characteristic data satisfy one or more consistency criteria. Examples of consistency criteria are described above with reference to FIG. 4. If the device 106 determines that the one or more consistency criteria are satisfied, the device 106 continues operating using the trained machine learning model, and routine returns to 412 to process the next set of input data at the next designated time.

If the device determines that the one or more consistency criteria are not satisfied, the device 106 sends, at 616, the second characteristic data to the device management system 104. The device management system 104 receives the second characteristic data at 618, and determines, at 620, properties for a new set of training data for retraining the machine learning model running on the device 106.

The method of FIG. 6 requires less data to be transmitted from the device 106 to the data management system 104, because the device 106 only sends the second characteristic data to the device management system 104 when he device determines that the second characteristic data and the first characteristic data do not satisfy the consistency conditions. However, as mentioned above, in order for the method of FIG. 6 to be carried out, the device 106 must be provided with a comparison routine for determining whether two sets of characteristic data are consistent. This takes up additional space in the memory 202 of the device 106, and also requires the device 106 to perform additional processing. In cases where memory, processing resources, or power, are scarce at the device 106, the method of FIG. 4 may therefore be more suitable. On the other hand, in cases where network resources or connectivity at the device 106 are scarce, the method of FIG. 6 may be more suitable.

In the examples described above, the data processing system 104 determines properties for a new set of training data upon determining that the machine learning model is not competent for use with a set of input data, and furthermore may initiate retraining of the machine leaning model. In other examples, the data processing system 104 may perform other actions upon determining that the machine learning model is not competent for use with the input data. For example, the data management system 104 may send a signal to the device 106, causing the device 106 to shut down or otherwise alter its mode of operation. This may be valuable if, for example, use of the machine learning model with input data for which the machine learning model is not competent could have costly or dangerous consequences. Additionally, or alternatively, the device 106 may generate an alert for a human user, for example to be transmitted to the client system 102. In some examples, input data may be out of range due to human error during maintenance or deployment of the device 106. For example, if the sensors 304 of the device 106 include a camera, a human error could be leaving a lens cap on the camera when deploying the camera. In a further example, input data may become out of range due to sensor degradation, or obstruction of the sensors 304 for example due to dirt. If the device operator is alerted that there may be a problem with the device 106, the device operator can manually check the device 106 and perform any necessary maintenance of the device 106 if necessary. In order to provide assistance to the user, the generated alert may include information indicative of the nature of the discrepancy between the input data and the training data, and may even include suggestions as to the cause of the discrepancy.

The above embodiments are to be understood as illustrative examples of the invention. Further embodiments of the invention are envisaged. For example, although in the examples above, the device management system determines properties for the new set of training data, in other examples the device itself may determine properties for the new set of training data, and send a request to the device management system to retrain the model using training data having those properties. Furthermore, the methods described herein are not limited to IoT applications, and may be used in any case where a machine learning model running on a device is trained remotely. In a further example, a computer program product may be provided comprising machine-readable instructions which, when executed by processing circuitry of a system or device, cause the system or device to implement the methods performed by the device management system 104 or device 106 as described above.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A system comprising:
a device management infrastructure arranged to process a set of training data using a data transformation model to generate first characteristic data indicative of values of one or more characteristics for the set of training data; and
a device communicatively coupled to the device management infrastructure and comprising memory circuitry arranged to store:
a machine learning model trained using the set of training data; and
a copy of the data transformation model,
wherein:
the device is arranged to process a set of input data using the copy of the data transformation model to generate second characteristic data indicative of values of said one or more characteristics for the set of input data; and
at least one of the device and the device management infrastructure is arranged to determine whether the first characteristic data and the second characteristic data satisfy one or more consistency criteria indicative of consistency between the set of training data and the set of input data.

2. The system of claim 1, wherein the one or more characteristics comprise one or more mathematical moments.

3. The system of claim 1, wherein the device further comprises one or more sensors arranged to generate the input data.

4. The system of claim 1, arranged to generate an alert upon said at least one of the device and the device management infrastructure determining that the first characteristic data and the second characteristic data do not satisfy the one or more consistency criteria.

5. The system of claim 1, wherein the device management architecture is further arranged to:
train the machine learning model using the set of training data; and
transmit the trained machine learning model to the device.

6. The system of claim 1, wherein the device management infrastructure is arranged to update the machine learning model stored in the memory circuitry of the device upon said at least one of the device and the device management infrastructure determining that the first characteristic data and the second characteristic data do not satisfy the one or more consistency criteria.

7. The system of claim 6, wherein:
the set of training data is a first set of training data; and
updating the machine learning model comprises:
retraining the machine learning model using a second set of training data, the second set of training data being dependent upon the determined values of said one or more characteristics for the set of input data; and
sending the retrained machine learning model to the device.

8. The system of claim 7, wherein:
the one or more characteristics comprise one or more mathematical moments; and
the device management infrastructure is arranged to determine values of the mathematical moments for the second set of training data based on the values of the mathematical moments for the set of input data and values of the mathematical moments for the first set of training data.

9. The system of claim 7, wherein:
the device management infrastructure is further arranged to train a machine learning classifier to determine whether candidate training data points are consistent with the first set of training data; and
the second set of training data is determined using the trained machine learning classifier such that data points in the second set of training data are not consistent with the first set of training data.

10. The system of claim 1, wherein:
the device management infrastructure is arranged to transmit the first characteristic data to the device; and
the device is arranged to determine whether the first characteristic data and the second characteristic data satisfy the one or more consistency criteria.

11. The system of claim 1, wherein:
the device is arranged to transmit the second characteristic data to the device management infrastructure; and
the device is arranged to determine whether the first characteristic data and the second characteristic data satisfy the one or more consistency criteria.

12. A device management system arranged to:
process a set of training data for a machine learning model using a data transformation model to generate first characteristic data indicative of values of one or more characteristics for the set of training data;
receive second characteristic data from a device indicative of values of said one or more characteristics for a set of input data generated by the device; and
determine whether the first characteristic data and the second characteristic data satisfy one or more consistency criteria indicative of consistency between the set of training data and the set of input data.

13. The device management system of claim 12, further arranged to:
train the machine learning model using the set of training data; and
transmit the trained machine learning model to the device.

14. The device management system of claim 12, arranged to generate an alert upon determining that the first characteristic data and the second characteristic data do not satisfy the one or more consistency criteria.

15. The device management system of claim 12, further arranged to update the machine learning model stored on the device upon determining that the first characteristic data and the second characteristic data do not satisfy the one or more consistency criteria.

16. The device management system of claim 15, wherein:
the set of training data is a first set of training data; and
updating the machine learning model comprises:
retraining the machine learning model using a second set of training data, the second set of training data being dependent upon the determined values of said one or more characteristics for the set of input data; and
sending the retrained machine learning model to the device.

17. The device management system of claim 12, wherein:
the one or more characteristics comprise one or more mathematical moments; and
the device management infrastructure is arranged to determine values of the mathematical moments for the second set of training data based on the values of the mathematical moments for the set of input data and values of the mathematical moments for the first set of training data.

18. The device management system of claim 12, further arranged to train a machine learning classifier to determine whether candidate training data points are consistent with the first set of training data,
wherein the second set of training data is determined using the trained machine learning classifier such that data points in the second set of training data are not consistent with the first set of training data.

19. A device comprising memory circuitry and one or more sensors, wherein the memory circuitry is arranged to store:
a machine learning model; and
a data transformation model,
wherein the device is arranged to:
receive, from a device management system, first characteristic data indicative of one or more characteristics for a set of training data used to train the machine learning model;
generate, using the one or more sensors, a set of input data;
process, the generated set of input data using the data transformation model to determine second characteristic data indicative of values of a set of data characteristics for the set of input data; and
determine whether the first characteristic data and the second characteristic data satisfy one or more consistency criteria indicative of consistency between the set of training data and the set of input data.

20. The system of claim 1, arranged to generate an alert upon said at least one of the device and the device management system determining that the first characteristic data and the second characteristic data do not satisfy the one or more consistency criteria.
